(19) United States
(12) Patent Application Publication
(10) Pub. No.: US 2022/0194287 A1
(43) Pub. Date: Jun. 23, 2022

(54) MOUNTABLE FABRIC ASHTRAY

(71) Applicant: Jesse Tyler Lockamy, Willow Spring, NC (US)

(72) Inventor: Jesse Tyler Lockamy, Willow Spring, NC (US)

(21) Appl. No.: 17/467,771

(22) Filed: Sep. 7, 2021

Related U.S. Application Data
(60) Provisional application No. 63/128,395, filed on Dec. 21, 2020.

(51) Int. Cl. B60N 3/12; A24F 19/00; B32B 7/12; B32B 5/02; B32B 5/26; B65D 33/14

(52) U.S. Cl. CPC B60N 3/12; A24F 19/00; B32B 7/12; B32B 5/024; B32B 5/263; B65D 33/14; B32B 2255/26; B32B 2307/3065; B32B 2307/712; B32B 2262/101; B32B 2250/02; B32B 2250/20; B32B 2255/02; B32B 2439/02

(57) ABSTRACT

A mountable ashtray having a first and a second wall defining an interior cavity therebetween, the first and second walls defining interior surfaces which are fire resistant, and exterior surfaces, wherein at least one of the walls includes a releasable connector.

### BACKGROUND OF THE INVENTION

The present invention relates generally to smoking receptacles, and more particularly to mountable ashtrays.

Smoking cigars, cigarettes, and other tobacco produces ash, cigarette butts, and cigar stubs as waste. This waste is litter which is unsightly, environmentally harmful, illegal, and dangerous. This is especially a problem in motor vehicles. Some vehicles do not have ashtrays. Others do, but smokers sometimes do not make use of them because of the odor it creates within the vehicle.

Accordingly, there remains a need for a convenient vehicle ashtray.

### BRIEF SUMMARY OF THE INVENTION

This need is addressed by a fabric ashtray including an inner fireproof material, that is mountable to the exterior of a vehicle or another hard surface.

According to one aspect of the invention, a mountable ashtray includes a first and a second wall defining an interior cavity therebetween, the first and second walls defining interior surfaces which are fire resistant, wherein at least one of the walls includes a releasable connector.

### BRIEF DESCRIPTION OF THE DRAWINGS

The invention may be best understood by reference to the following description taken in conjunction with the accompanying drawing figures in which:

FIG. 1 is a top plan view of a mountable ashtray constructed in accordance with an aspect of the present invention;

FIG. 2 is a front elevation view of the mountable ashtray of FIG. 1;

FIG. 3 is a bottom plan view of the mountable ashtray of FIG. 1;

FIG. 4 is a rear elevation view of the mountable ashtray of FIG. 1;

FIG. 5 is a side elevation view of the mountable ashtray of FIG. 1;

FIG. 6 is a schematic view showing the mountable ashtray attached to the exterior of an automobile door;

FIG. 7 is a view of interior fireproof material, cut into a blank to be used in creating an ashtray;

FIG. 8 is a view showing exterior waterproof material, cut into a blank to be used in creating an ashtray;

FIG. 9 is a view showing the material of FIG. 8, with magnets placed thereon; and

FIG. 10 is a partially-broken-away view showing the interior material of FIG. 7 placed over the exterior material of FIG. 9, with perimeter flaps of the exterior material folded over the interior material, prior to a final fold of the dual-layered fabric structure.

### DETAILED DESCRIPTION OF THE INVENTION

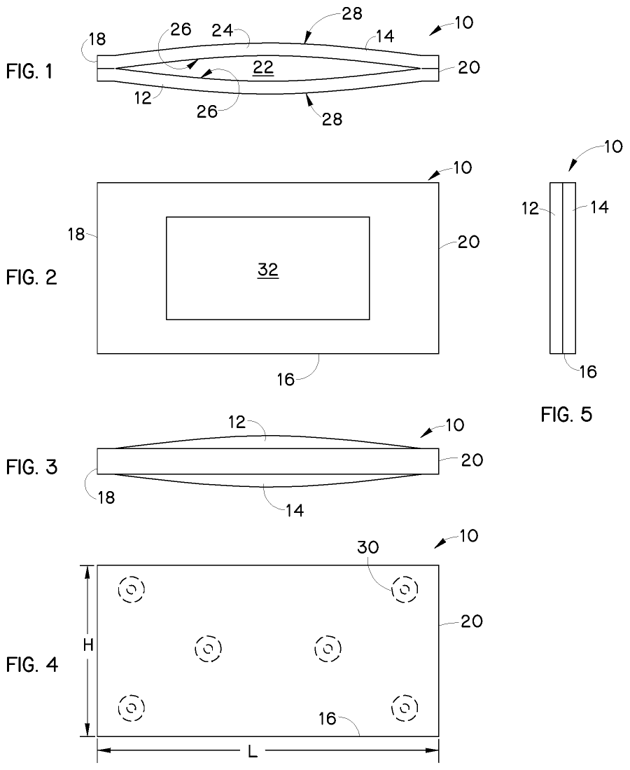

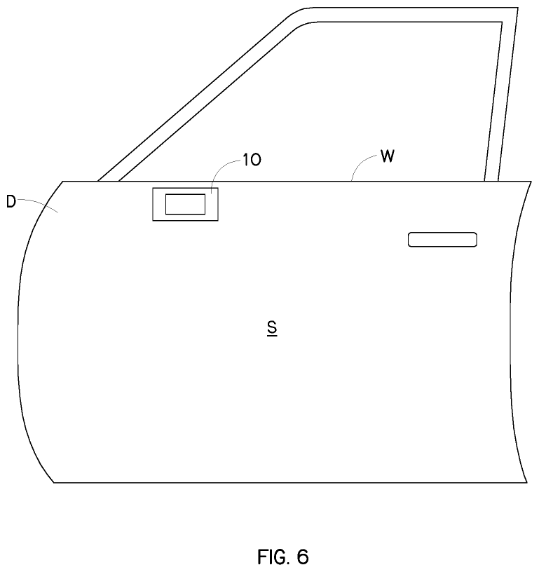

Referring to the drawings wherein identical reference numerals denote the same elements throughout the various views, FIGS. 1-5 illustrate an exemplary mountable ashtray 10 constructed according to an aspect of the present invention.

The mountable ashtray 10 is a pouch structure comprising flexible fabric first and second walls 12, 14 which are joined together along a bottom edge 16 and a pair of spaced-apart side edges 18, 20. An internal cavity 22 is defined between the walls 12, 14, and is accessible through a mouth 24 formed when the walls 12, 14 are flexed apart. The ashtray 10 has interior surfaces 26 defined by inside faces of the walls 12, 14 and exterior surfaces 28 defined by outside faces of the walls 12, 14.

As used herein, the term “fabric” refers to material made from woven or knitted fibers, as well as other flexible lightweight materials, such as some plastics or rubbers.

The size of the mountable ashtray 10 may be varied to suit a particular application. In general, a larger size provides more storage volume, while a smaller size is more portable. In one example, the mountable ashtray may have an overall length “L” of approximately 12.7 cm (5 inches) and an overall height “H” of approximately 6.35 cm (2.5 inches).

The interior surfaces 26 are fireproof or fire-resistant, for the purpose of preventing damage from tobacco waste (e.g., ashes, cigarette butts) that may be hot and/or smoldering. The exterior surfaces 28 may be waterproof or water-resistant to permit outside use. As will be explained in more detail below, this combination of properties may be obtained by making the walls 12, 14 as two-layered structures.

At least one of the walls 12, 14 incorporates a suitable releasable connector (shown schematically at 30 in FIG. 4). As used herein, the term “releasable” refers to a connection that can be coupled and uncoupled in ordinary use without resorting to the use of tools. Non-limiting examples of suitable releasable connectors include magnets, hook-and-loop fasteners (e.g. VELCRO), and weak adhesives. The releasable connector 30 may be internal to one or both of the walls 12, 14 or positioned on their external surfaces. If desired, one of the walls 12, 14 may be provided with space for a product logo 32.

The ashtray 10 is used by attaching it to a suitable supporting surface. As seen in FIG. 6, the ashtray 10 is particularly suitable for being attached to the exterior skin “S” of a car door “D” just below the window sill “W”. In this position, a driver can easily place ashes or a cigarette butt into the ashtray 10.

The natural thickness and resiliency of the material tends to hold the mouth 24 in a closed position. This safely holds tobacco waste. The fireproof material prevents burning or fire hazard. Smoke and odors are kept outside the vehicle. The ashtray 10 can be easily detached to be used at a different vehicle or location, or for being emptied or cleaned.

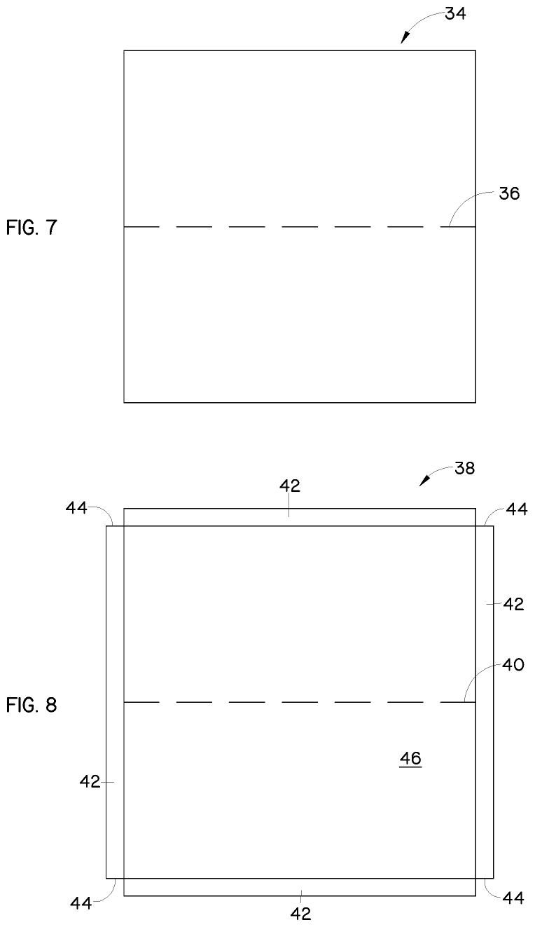

An example of how the mountable ashtray may be constructed will now be described with references to FIGS. 7-10.

In this example, construction begins with a first blank 34 of interior material (FIG. 7). Construction may be simplified by using a first blank 34 having at least one line of symmetry so that it can be folded along a fold line 36 to define the bottom edge 16 described above. In one example, the first blank 34 is a square with a side length of approximately 13 cm (5 inches).

The interior material is fireproof and/or fire-retardant to a sufficient degree that tobacco waste which may be burning or smoldering will not damage or ignite the ashtray 10. The fireproof and/or fire retardant properties may be imparted by the basic material used and/or by some combination of coatings or treatment. A nonlimiting example of a fireproof material is woven glass fiber cloth.

As seen in FIG. 8, a second blank 38 of exterior material is also provided. Construction may be simplified by using a second blank 38 having at least one line of symmetry so that it can be folded along a fold line 40 to define the bottom edge 16 described above. In one example, the second blank 38 is a square with a side length of approximately 14 cm (5.5 inches). Material may be removed from the corners to form flaps 42 along the edges of the second blank 38. In one example, square notches 44 of approximately 6.35 mm (0.25 inches) width are cut out, leaving flaps 42 approximately 6.35 mm (0.25 inches) wide surrounding a central field 46 which is a square with a side length of approximately 13 cm (5 inches).

The exterior material may be weather resistant. This implies some degree of water resistance such that the ashtray 10 may be used outdoors without being damaged or degraded or getting waterlogged. The waterproof and/or water resistant properties may be imparted by the basic material used and/or by some combination of coatings or treatment. A nonlimiting example of a waterproof material are various fabrics sold commercially as “marine canvas”. These may include, for example, vinyl fabric, or woven or knitted fabrics that have been coated or laminated. In one example, the exterior material may be polyester Oxford cloth, optionally coated with a waterproofing material such as polyvinylchloride (PVC).

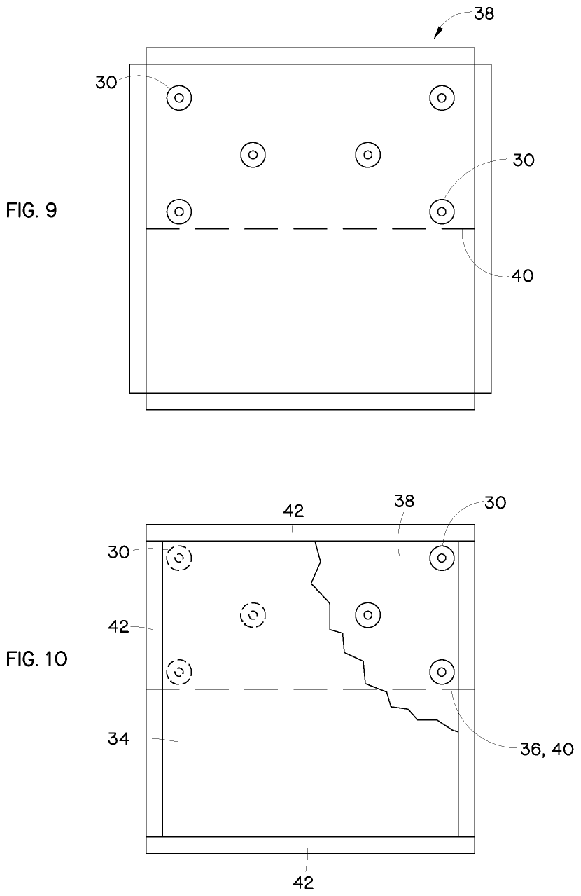

FIG. 9 shows the second blank 38 of exterior material with a releasable connector 30 in the form of several disposed thereon. One suitable example are disk magnets with a diameter of 12.7 mm (0.5 inch). These may be secured to the second blank 38 with adhesive, for example.

FIG. 10 shows the first blank 34 placed overlying the second blank 38, concealing the magnets 30 between the two fabric layers. FIG. 10 also shows the flaps 42 which have been folded over the edge of the first blank 34 and secured in place to create a dual-square with magnets between the fabric layers. In one example, adhesive may be used to bond the two layers 34, 38.

A final step in construction is to fold the two-layered structure together along the coincident fold lines 36, 40 with the first blank 34 facing inwards, and join the edge portions together, for example using thread stitching or adhesive.

While folding has been described as a manufacturing process, alternatively, the walls 12, 14 could be made from individual pieces connected together, e.g., the walls 12, 14 could be connected along three edges. The magnets or other releasable connector could be attached to the first blank 34 instead of the second blank 38, and either of the blanks 34, 38 could incorporate the flaps 42, or the flaps could be eliminated.

The mountable ashtray 10 described herein has numerous features and advantages. It is portable and can be easily used in different vehicles. Because it can be mounted outside the vehicle, it prevents odors in vehicles. It is more compact than other kinds of ashtrays. Its structure is effective to extinguish cigarettes and other tobacco waste.

The foregoing has described a mountable ashtray. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A mountable ashtray, comprising a flexible first wall and a flexible second wall defining an interior cavity therebetween, the first and second walls defining interior surfaces which are fire resistant, and exterior surfaces, wherein at least one of the walls includes a releasable connector.

2. The mountable ashtray of claim 1, wherein the releasable connector comprises one or more magnets.

3. The mountable ashtray of claim 2, wherein the one or more magnets are disposed between inner and outer layers of one of the walls.

4. The mountable ashtray of claim 1, wherein the releasable connector comprises hook-and-loop material.

5. The mountable ashtray of claim 1, wherein the exterior surfaces are weather resistant.

6. The mountable ashtray of claim 1, wherein each of the walls comprises an inside layer defining the interior surface and an outside layer defining the exterior surface.

7. The mountable ashtray of claim 6 wherein the inside layer comprises woven glass fiber cloth.

8. The mountable ashtray of claim 6, wherein the outside layer comprises coated Oxford cloth.

9. The mountable ashtray of claim 1, wherein the inner and outer layers are bonded together by an adhesive.

10. The mountable ashtray of claim 1, wherein the first and second walls are defined by a blank of material which is folded along a fold line to define a bottom edge and spaced-apart side edges, the side edges being attached to each other.
